(19) United States
(12) Patent Application Publication
(10) Pub. No.: US 2024/0289614 A1
(43) Pub. Date: Aug. 29, 2024

(54) SYSTEM AND METHOD FOR HYPERNETWORK GUIDED DOMAIN DECOMPOSITION IN PHYSICS-INFORMED NEURAL OPERATORS

(71) Applicant: Quantiphi, Inc., Marlborough, MA (US)

(72) Inventors: Dagnachew Birru, Marlborough, MA (US); Rishi Yash Parekh, Mumbai (IN); Milad Ramezankhani, Toronto (CA); Anirudh Deodhar, Mumbai (IN)

(21) Appl. No.: 18/656,366

(22) Filed: May 6, 2024

(51) Int. Cl. G06N 3/08

(52) U.S. Cl. CPC G06N 3/08

(57) ABSTRACT

A method and system for hypernetwork guided domain decomposition in Physics-Informed Neural Operators (PINOs). The method includes identifying a presence of at least one discontinuity in data associated with a target domain to be analyzed by a PINO. Identification of the presence is at least of a successful identification or an unsuccessful identification. The method further includes generating a plurality of sub-domains for the target domain. The plurality of sub-domains is generated uniformly upon the unsuccessful identification, and the plurality of sub-domains is generated based on a predefined discontinuity criteria upon the successful identification. The method further includes generating intra-subdomain points with respect to each of the plurality of sub-domains. The method further includes extracting a plurality of sub-domain identifiers, upon generating the intra-subdomain points, using a pre-defined feature extraction technique. The method further includes providing the plurality of sub-domain identifiers as an input to a hypernetwork.

### FIELD OF THE INVENTION

The present disclosure relates to training of Physics-Informed Neural Operators (PINO), and more specifically to a method and system for hypernetwork guided domain decomposition in PINOs, which is particularly useful for learning highly nonlinear systems with long temporal domains and discontinuities.

### BACKGROUND OF THE INVENTION

Machine learning, particularly deep learning, has shown great promise in a wide range of applications, including the simulation of physical systems. Physics-Informed Neural Operators (PINO) have been introduced as a data-agnostic alternative to traditional numerical simulation methods. PINOs incorporate known physical laws into the learning process, allowing them to make accurate predictions even with limited data.

However, training PINOs for complex systems, particularly those with long temporal domains and discontinuities, presents significant challenges. PINOs often fail to converge and achieve acceptable accuracy when learning such systems due to some inherent limitations associated with the technique.

Domain decomposition has been introduced as a viable solution for training PINN/PINOs. By dividing the problem domain into smaller sub-domains, each of which can be solved independently, domain decomposition can significantly improve the convergence and accuracy of PINNs. However, domain decomposition often leads to high computational costs as multiple neural networks need to be trained simultaneously or sequentially. Furthermore, no optimal and efficient strategy exists to determine the appropriate size and number of subdomains for each application.

Several methods have been proposed to address these challenges, including HyperDeepONet, APINNs, XPINNs, time marching, bc-PINNs, and multi-level overlapping domain decomposition. However, these methods either do not address the problems where domain decomposition is needed, especially for long time domain problems, complex geometries, and non linear phenomena, or they require separate networks to be built and composed together using complex “interface” conditions, which increases the computational cost.

Therefore, there is a need for a method and system that may effectively address the challenges in training PINOs for complex systems, particularly those with long temporal domains and discontinuities, without imposing additional computational cost.

### SUMMARY

The following embodiments presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide computer-implemented method for hypernetwork guided domain decomposition in Physics-Informed Neural Operators (PINOs), the method may include identifying a presence of at least one discontinuity in data associated with a target domain to be analyzed by a PINO. Identification of the presence is at least of a successful identification or an unsuccessful identification. The method may further include generating a plurality of sub-domains for the target domain. The plurality of sub-domains is generated uniformly upon the unsuccessful identification, and the plurality of sub-domains is generated based on a predefined discontinuity criteria upon the successful identification. The method may further include generating intra-subdomain points with respect to each of the plurality of sub-domains. The method may further include extracting a plurality of sub-domain identifiers corresponding to each of the plurality of subdomains, upon generating the intra-subdomain points, using a pre defined feature extraction technique. The method may further include providing the plurality of sub-domain identifiers as an input to a hypernetwork.

According to some example embodiments, the method further comprising embedding the plurality of sub-domain identifiers in a standard template for processing the plurality of sub-domain identifiers to the hypernetwork.

According to some example embodiments, generating the plurality of sub-domains comprises identifying a presence of spatial discontinuity of the at least one discontinuity in the data.

According to some example embodiments, the method further comprising performing at least one of, upon a successful identification of the presence of spatial discontinuity, generating a first set of sub-domains of the plurality of pre-defined sub-domains based on a spatial discontinuity criterion, or upon an unsuccessful identification of the presence of spatial discontinuity, identifying a temporal discontinuity of the at least one discontinuity in the data.

According to some example embodiments, the method further comprising upon successful identification of the presence of temporal discontinuity, generating a second set of sub-domains of the plurality of pre-defined sub-domains based on a temporal discontinuity criterion, or upon unsuccessful identification of the presence of temporal discontinuity, generating the plurality of sub-domains for the target domain uniformly, in all dimensions.

According to some example embodiments, the spatial discontinuity corresponds to abrupt spatial variations in the data, wherein the spatial variations comprise variations in geometrical parameter, or sharp change in boundary conditions with respect to spatial coordinate.

According to some example embodiments, the temporal discontinuity corresponds to abrupt temporal variations in the data, the temporal variations comprise sudden shock or sharp change in the boundary conditions with respect to time.

According to some example embodiments, the method further comprising generating combinations of parameters of a physical system that are to be varied.

According to some example embodiments, the intra-subpoints comprise initial points for training, boundary points, collocation points for enforcing physics-informed constraints, and interface points between adjacent sub-domains for maintaining physical continuity.

According to some example embodiments, the method further comprising iteratively training the PINO with the combinations of parameters until an error falls below a predefined threshold.

According to some example embodiments, the feature extraction technique is a statistical analysis technique.

Some example embodiments disclosed herein provide a computer system for hypernetwork guided domain decomposition in Physics-Informed Neural Operators (PINOs), the computer system comprising one or more computer processors, one or more computer readable memories, one or more computer readable storage devices, and program instructions stored on the one or more computer readable storage devices for execution by the one or more computer processors via the one or more computer readable memories, the program instructions comprising identifying a presence of at least one discontinuity in data associated with a target domain to be analyzed by a PINO, identification of the presence is at least of a successful identification or an unsuccessful identification. The one or more processors are further configured for generating a plurality of sub-domains for the target domain. The plurality of sub-domains is generated uniformly upon the unsuccessful identification, and the plurality of sub-domains is generated based on a predefined discontinuity criteria upon the successful identification. The one or more processors are further configured for generating intra-subdomain points with respect to each of the plurality of sub-domains. The one or more processors are further configured for extracting a plurality of sub-domain identifiers corresponding to each of the plurality of subdomains, upon generating the intra-subdomain points, using a pre-defined feature extraction technique. The one or more processors are further configured for providing the plurality of sub-domain identifiers as an input to a hypernetwork.

Some example embodiments disclosed herein provide a non-transitory computer readable medium having stored thereon computer executable instruction which when executed by one or more processors, cause the one or more processors to carry out operations for hypernetwork guided domain decomposition in Physics-Informed Neural Operators (PINOs), the operations comprising identifying a presence of at least one discontinuity in data associated with a target domain to be analyzed by a PINO, identification of the presence is at least of a successful identification or an unsuccessful identification. The operations further comprising generating a plurality of sub-domains for the target domain. The plurality of sub-domains is generated uniformly upon the unsuccessful identification, and the plurality of sub-domains is generated based on a predefined discontinuity criteria upon the successful identification. The operations further comprising generating intra-subdomain points with respect to each of the plurality of sub-domains. The operations further comprising extracting a plurality of sub-domain identifiers corresponding to each of the plurality of subdomains, upon generating the intra-subdomain points, using a pre-defined feature extraction technique. The operations further comprising providing the plurality of sub-domain identifiers as an input to a hypernetwork.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system for hypernetwork guided domain decomposition in PINOs, in accordance with an example embodiment.

FIG. 2 is a block diagram illustrating various modules within a memory of a computing device configured for hypernetwork guided domain decomposition in PINOs, in accordance with an example embodiment.

FIG. 3 illustrates a flow diagram of a method for hypernetwork guided domain decomposition in PINOs, in accordance with an example embodiment.

FIG. 4 illustrates a flow diagram of a method 400 for training the PINO, in accordance with an example embodiment.

FIG. 5 illustrates a flow diagram of a method 500 for generating a plurality of sub-domains, in accordance with an example embodiment.

FIG. 6 illustrates a flow diagram of a method 600 for generating a plurality of sub-domains, in accordance with an example embodiment.

FIG. 7 illustrates an exemplary process flow 700 for generating a set of variables for a physical system, in accordance with an example embodiment.

FIG. 8 illustrates an exemplary process flow 800 for training the PINO, in accordance with an example embodiment.

FIG. 9 illustrates an exemplary architecture 900 of neural operator for hypernetwork guided decomposition, in accordance with an example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Physics-Informed Neural Operators (PINO)” may represent a type of machine learning framework that combines principles from physics with neural network architectures, for mapping relationships between functional spaces. These PINOs are utilized for modeling complex systems, particularly those characterized by nonlinear dynamics, long temporal domains, and discontinuities.

The term “hypernetwork” may refer to a type of neural network architecture used in machine learning. A hypernetwork is a neural network architecture that, given a set of input configurations, generates the corresponding weights for another network often referred to as the primary network.

The term “machine learning model” may be used to refer to a computational or statistical or mathematical model that is trained on classical ML modelling techniques with or without classical image processing. The “machine learning model” is trained over a set of data and using an algorithm that it may be used to learn from the dataset.

The term “artificial intelligence” may be used to refer to a model built using simple or complex Neural Networks using deep learning techniques and computer vision algorithms. Artificial intelligence model learns from the data and applies that learning to achieve specific pre defined objectives.

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

### End of Definitions

As described earlier, PINOs have emerged as a powerful tool for simulating physical systems. However, training PINOs for complex systems, particularly those with long temporal domains and discontinuities, presents significant challenges. The inherent limitations inherited from Physics-Informed Neural Networks (PINNs) often lead to failure in achieving acceptable accuracies when learning such systems. Domain decomposition has been introduced as a solution for training PINOs. By dividing the problem domain into smaller sub-domains, each of which can be solved independently, domain decomposition may significantly improve the convergence and accuracy of PINOs. However, this approach often leads to high computational costs as multiple neural networks need to be trained simultaneously or sequentially. Furthermore, determining the appropriate size and number of subdomains for each application lacks an optimal and efficient strategy. The present disclosure addresses these challenges by introducing a method and system for hypernetwork guided domain decomposition in PINOs. The proposed method and system significantly reduce the computational cost and enables neural operators to learn nonlinearities and discontinuities in complex geometries without imposing significant additional computational cost. It also provides an automated learning strategy for digital twin systems by adaptively updating the domain decomposition architecture during the training.

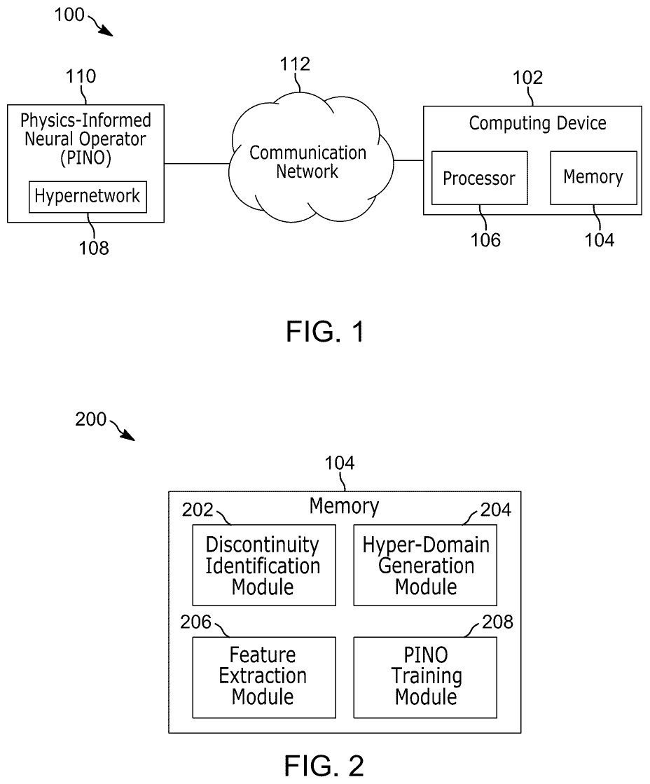

Embodiments of the present disclosure may provide a method, a system, and a computer program product for hypernetwork guided domain decomposition in PINOs. The method, the system, and the computer program product performing hypernetwork guided domain decomposition in PINOs in such an improved manner are described with reference to FIG. 1 to FIG. 9 as detailed below.

FIG. 1 illustrates a block diagram of an environment of a system 100 for hypernetwork guided domain decomposition in PINOs, in accordance with an example embodiment. The system 100 includes a computing device 102, a PINO 110, and a hypernetwork 108 embedded within the PINO 110. The computing device 102 may be communicatively coupled with the hypernetwork 108 and the PINO 110 via a communication network 112. Examples of the computing device 102 may include, but are not limited to, a server, a desktop, a laptop, a notebook, a tablet, a smartphone, a mobile phone, an application server, or the like.

The communication network 112 may be wired, wireless, or any combination of wired and wireless communication networks, such as cellular, Wi-Fi, internet, local area networks, or the like. In one embodiment, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may include a memory 104, and a processor 106. The term “memory” used herein may refer to any computer-readable storage medium, for example, volatile memory, random access memory (RAM), non-volatile memory, read only memory (ROM), or flash memory. The memory 104 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 106 may retrieve computer program code instructions that may be stored in the memory 104 for execution of the computer program code instructions. The processor 106 may be embodied in a number of different ways. For example, the processor 106 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 106 may include one or more processing cores configured to perform independently. A multi-core processor may enable multiprocessing within a single physical package. Additionally, or alternatively, the processor 106 may include one or more processors configured in tandem via the bus to enable independent execution of instructions, pipelining and/or multithreading.

Additionally, or alternatively, the processor 106 may include one or more processors capable of processing large volumes of workloads and operations to provide support for big data analysis. In an example embodiment, the processor 106 may be in communication with a memory 104 via a bus for passing information among components of the system 100.

The memory 104 may be non-transitory and may include, for example, one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor 106). The memory 104 may be configured to store information, data, contents, applications, instructions, or the like, for enabling the apparatus to carry out various functions in accordance with an example embodiment of the present disclosure. For example, the memory 104 may be configured to buffer input data for processing by the processor 106.

The computing device 102 may be capable of performing hypernetwork guided domain decomposition in the PINO 110. The memory 104 may store instructions that, when executed by the processor 106, cause the computing device 102 to perform one or more operations. For example, the computing device 102 may identify a presence of at least one discontinuity in data associated with a target domain that is to be analyzed by the PINO 110. The identification of the presence is either successful or unsuccessful. Based on the identification, the computing device 102 may generate a plurality of sub-domains for the target domain. If the identification is unsuccessful, the sub-domains are generated uniformly. If the identification is successful, the sub-domains are generated based on a predefined discontinuity criterion.

The computing device 102 may further generate intra-subdomain points with respect to each of the plurality of sub-domains. It extracts a plurality of sub-domain identifiers corresponding to each of the plurality of subdomains, upon generating the intra-subdomain points, using a feature extraction technique. The plurality of sub-domain identifiers is then provided as an input to the hypernetwork 108.

The hypernetwork 108, which may be communicatively coupled with the computing device 102 via the communication network 112, is configured to receive the plurality of sub-domain identifiers as input. In particular, the plurality of sub-domain identifiers that are extracted may be embedded in a standard template for processing the plurality of sub-domain identifiers to the hypernetwork 108.

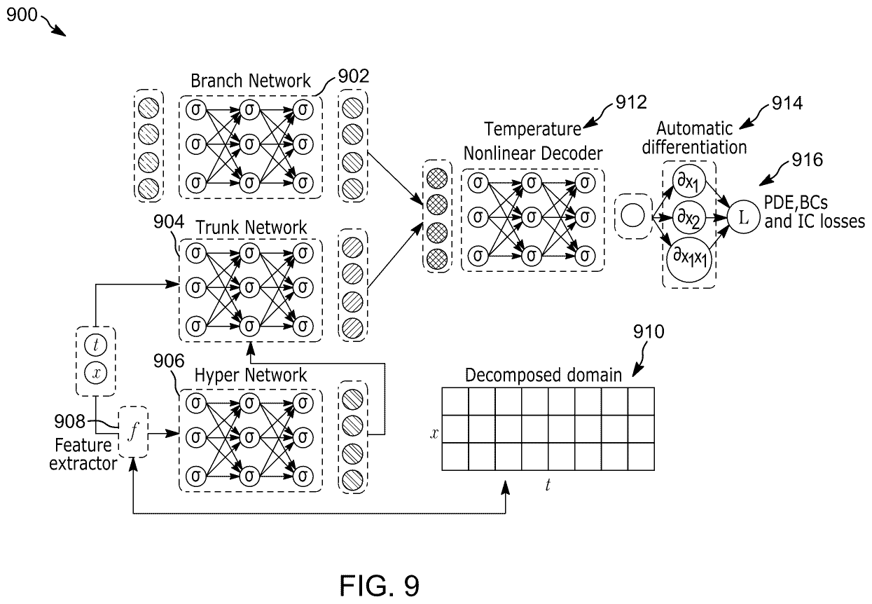

In an embodiment, a separate set of variable parameters may be generated for training the PINO 110. These variable parameters may correspond to combinations of parameters of a physical system that are to be varied. In other words, these combinations parameters, independent of the hypernetwork part, represent different possible states of the physical system and may be based on either default or user-specified ranges. The parameters may comprise operating conditions, design aspects of the system, material characteristics of the system. These parameters are then fed into a branch network of neural operator (as shown in FIG. 9) for training purpose. The PINO 110 may be iteratively trained with the combinations of parameters until an error falls below a predefined threshold. The complete process followed by the system 100 is explained in detail in conjunction with FIG. 2 to FIG. 9.

FIG. 2 illustrates a block diagram 200 illustrating various modules within the memory 104 of the computing device 102 configured for hypernetwork guided domain decomposition in PINOs, in accordance with an example embodiment. The memory 104 may include a discontinuity identification module 202, a hyper-domain generation module 204, a feature extraction module 206, and a PINO training module 208.

In order to perform hypernetwork guided domain decomposition in the PINO, initially the discontinuity identification module 202 may identify the presence of at least one discontinuity in the data associated with a target domain to be analyzed by the PINO. The identification of the presence is either successful or unsuccessful.

Based on the identification result, the hyper-domain generation module 204 generates a plurality of sub-domains for the target domain. If the identification is unsuccessful, the sub-domains are generated uniformly. If the identification is successful, the sub-domains are generated based on a predefined discontinuity criterion.

In a more elaborative way, the hyper-domain generation module 204 may generate the plurality of sub-domains by identifying a presence of spatial discontinuity of the at least one discontinuity in the data. The spatial discontinuity may correspond to abrupt spatial variations in the data, and the spatial variations may be variations in in geometrical parameter, or sharp change in boundary conditions with respect to spatial coordinate. In other words, the spatial variations may be variations in geometrical parameters, such as abrupt changes in geometry such as the presence of a wall separating two flow channels. Another example of the spatial variations may be a sharp change in boundary conditions with respect to spatial coordinates, such as one part of a channel being heated to 100 degrees Celsius while another part is cooled to 20 degrees Celsius, with a sharp transition between the two.

Upon a successful identification of the presence of spatial discontinuity, the hyper-domain generation module 204 may generate a first set of sub-domains of the plurality of pre defined sub-domains based on a spatial discontinuity criterion. The first set of sub-domains may be, for example, splitting the domains where there is discontinuity in geometry parameter or sharp change in boundary condition with respect to spatial coordinate. The spatial discontinuity criterion for such sub-domains may be, for example, if the geometry exhibits two distinct areas where a discontinuous solution is expected, such as two channels separated by the wall, the module may divide the sub-domains along that wall in the ‘x’ dimension (e.g., space dimension).

Upon an unsuccessful identification of the presence of spatial discontinuity, the hyper-domain generation module 204 may identify a temporal discontinuity of the at least one discontinuity in the data. The temporal discontinuity may correspond to abrupt temporal variations in the data, and the temporal variations may be sudden shock or sharp change in the boundary conditions with time.

Additionally, upon successful identification of the presence of temporal discontinuity, the hyper-domain generation module 204 may generate a second set of sub-domains of the plurality of pre-defined sub-domains based on a temporal discontinuity criterion. The second set of sub-domains may be, for example, splitting the domains where there is discontinuity in sudden shock or sharp change in the boundary conditions over time. The temporal discontinuity criterion for these sub-domains may be, for example, identifying areas where the response of the system is expected to be perturbed due to such discontinuity in boundary conditions, resulting in the splitting of domains along the ‘t’ dimension (e.g., time dimension).

Upon unsuccessful identification of the presence of temporal discontinuity, the hyper domain generation module 204 may generate the plurality of sub-domains for the target domain uniformly, in all dimensions, particularly in both space and time dimensions.

Further, the hyper-domain generation module 204 may generate intra-subdomain points with respect to each of the plurality of sub-domains. The intra-subpoints may include initial points for training, boundary points, collocation points for enforcing physics-informed constraints, and interface points between adjacent sub-domains. The generation of intra-subpoints is closely linked with the extraction of identifiers, as these identifiers serve as a function of the intra-sub-domain points. For example, for a sub-domain spanning 0-1 in space (x) and 5-10 in time (t), the identifier set may include sub-domain center (0.5, 7.5), maximum (1, 10), and minimum (0, 5) for each dimension ‘x’ and ‘t’. The intra-subdomain points may lie somewhere in the range above, but the identifiers may essentially map them to specific features identified.

Upon generating the intra-subdomain points and once the sub-domains are generated, the feature extraction module 206 may extract a plurality of sub-domain identifiers corresponding to each of the plurality of subdomains. This is done using a pre-defined feature extraction technique. This technique aims to capture the unique spatial and temporal patterns, distributions, and characteristics present in the data, enabling effective representation of the sub-domains for further analysis and processing.

One commonly utilized feature extraction technique may be statistical analysis. Statistical analysis techniques offer a robust framework for extracting meaningful information from data by quantifying various aspects of its distribution, variability, and structure. Several statistical methods may be employed to extract sub-domain identifiers, including but not limited to:

Mean and Standard Deviation: Computing the mean and standard deviation of data points within each sub-domain provides information about the central tendency and spread of values, helping to characterize the distribution and variability of the data.

Histogram Analysis: Constructing histograms of data points within each sub-domain allows for visualizing the distribution of values and identifying potential clusters or patterns present in the data.

Principal Component Analysis (PCA): PCA is a dimensionality reduction technique that identifies the principal components or axes of variation within the data. By projecting data points onto these components, PCA can reveal underlying structures and relationships between variables in each sub-domain.

Cluster Analysis: Employing clustering algorithms such as k-means or hierarchical clustering can group similar data points within each sub-domain, enabling the identification of distinct clusters or regions with similar characteristics.

Frequency Analysis: Analyzing the frequency domain characteristics of temporal data using techniques such as Fourier analysis or wavelet transforms can reveal periodicities, oscillations, or transient events present in each sub-domain.

Spatial Correlation Analysis: Examining the spatial correlation structure of data points within each sub-domain can provide insights into spatial dependencies, gradients, or spatial patterns present in the data.

Therefore, the feature extraction technique utilizes statistical analysis methods to quantify and extract relevant information from the data, allowing for the generation of sub-domain identifiers that effectively capture the unique characteristics of each sub-domain.

The extracted sub-domain identifiers may be then provided as an input to the hypernetwork. Simultaneously, the PINO training module 208, in communication with the hypernetwork, may generate combinations of parameters of a physical system that are to be varied. The combinations of parameters may be various aspects of the physical system, including boundary conditions, initial conditions, material properties, dimensions, and other relevant information that may be input to the branch network for train the PINO.

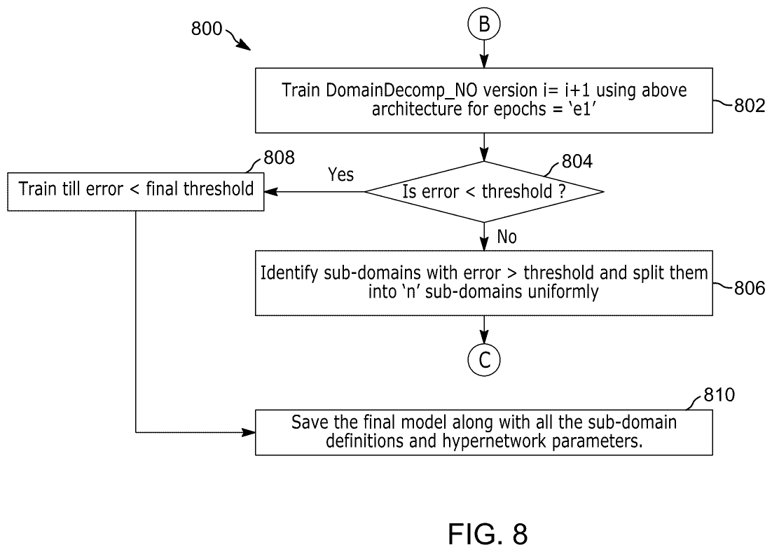

The PINO training module 208 may uses the combinations of parameters for iteratively training the PINO until an error falls below a predefined threshold. During each iteration, the hypernetwork generates new combinations of parameters based on the extracted sub-domain identifiers. These parameter combinations are then utilized to train the PINO, refining its performance with each iteration. The process of iteratively training the PINO is already explained in detail in conjunction with FIG. 8.

To illustrate, consider a sample architecture (later explained in FIG. 9) where the hypernetwork guides the domain decomposition and parameter generation process. The architecture includes a hypernetwork responsible for learning the dynamics of each sub-domain based on sub-domain identifiers. The parameter combinations are fed into the branch network, which forms part of the PINO. The branch network processes the input data and refines the model's predictions through iterative training, guided by the generated parameter combinations. This iterative process continues until the PINO achieves satisfactory accuracy, as determined by the predefined error threshold. By employing this iterative training approach and sample architecture, the PINO adapts and improves its performance over time, effectively capturing the underlying physics of the system under analysis.

Finally, the PINO training module 208 evaluates the performance and effectiveness of the trained PINO. This module conducts comprehensive evaluations to determine the accuracy, reliability, and generalizability of the trained models, providing valuable insights into their performance and suitability for real-world applications. The tasks performed by the PINO training module 212 may be for example:

Performance Metrics Calculation: The module may compute various performance metrics to quantify the accuracy and quality of the PINOs' predictions. Common metrics include mean squared error (MSE), mean absolute error (MAE), root mean squared error (RMSE), coefficient of determination (R-squared), or any other suitable error metric relevant to the specific application domain.

Validation Dataset Evaluation: The trained PINOs are evaluated using a separate validation dataset that was not used during the training process. This ensures an unbiased assessment of the models' performance and their ability to generalize to unseen data.

Comparison with Ground Truth: The predictions generated by the trained PINOs may be compared against the ground truth or observed data to assess their accuracy and fidelity. Discrepancies between predicted and actual values are analyzed to identify areas of improvement and potential sources of error.

Model Robustness Testing: The module may conduct robustness testing to assess the sensitivity of the PINOs to changes in input data, model parameters, or environmental conditions. This helps gauge the stability and reliability of the models under different scenarios and variations.

Error Analysis: Detailed error analysis may be performed to identify patterns or trends in prediction errors and diagnose potential shortcomings or limitations of the trained models. This analysis provides valuable insights for refining and improving the models' performance.

Validation of Physics Constraints: The module may validate whether the trained PINOs adhere to the underlying physics constraints imposed during the training process. This ensures that the models accurately capture the physical behavior of the system and produce physically plausible predictions.

Optimization and Fine-Tuning: Based on the evaluation results, the module may recommend optimization strategies or fine-tuning adjustments to further improve the performance of the PINOs. This iterative process helps refine the models and enhance their predictive capabilities.

In this way, the system enables hypernetwork guided domain decomposition in PINOs, thereby addressing the challenges in training PINOs for complex systems with long temporal domains and discontinuities, without imposing additional computational cost. This makes the system particularly useful for learning highly nonlinear systems in a variety of applications.

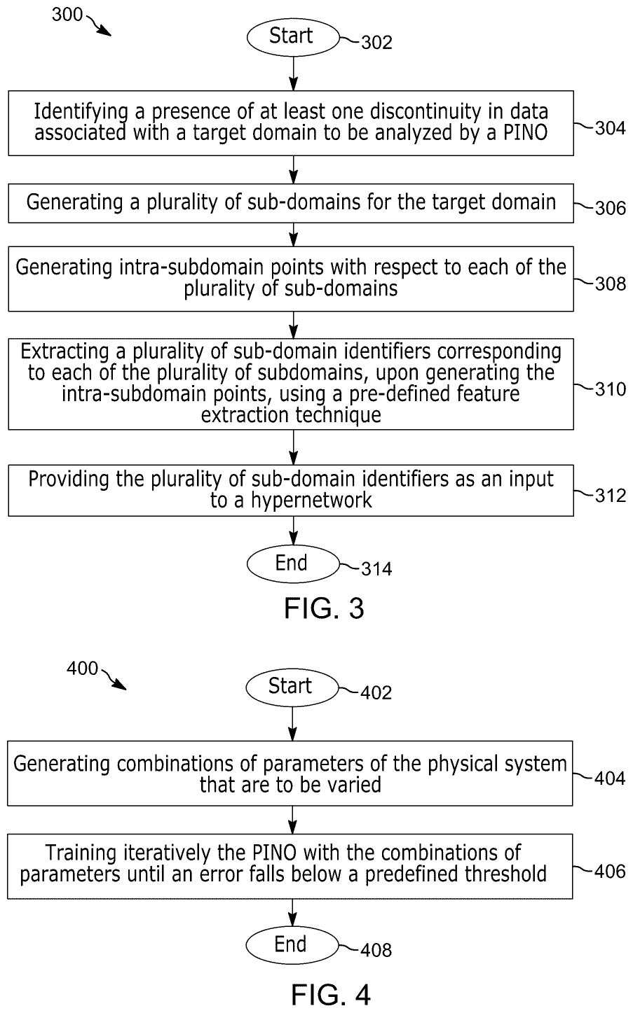

FIG. 3 illustrates a flow diagram of a method 300 for hypernetwork guided domain decomposition in PINOs, in accordance with an example embodiment. It will be understood that each block of the flow diagram of the method 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 300 illustrated by the flow diagram of FIG. 3 for hypernetwork guided domain decomposition may start at step 302. Further, the method 300 may include identifying a presence of at least one discontinuity in data associated with a target domain to be analyzed by a PINO, at step 304. Identification of the presence is at least of a successful identification or an unsuccessful identification.

The method 300, at step 306, may include generating a plurality of sub-domains for the target domain. The plurality of sub-domains may be generated uniformly upon the unsuccessful identification. The plurality of sub-domains may be generated based on a predefined discontinuity criteria upon the successful identification.

At step 308, the method 300 may include, generating intra-subdomain points with respect to each of the plurality of sub-domains.

At step 310, the method 300 may include, extracting a plurality of sub-domain identifiers corresponding to each of the plurality of subdomains, upon generating the intra-subdomain points, using a pre-defined feature extraction technique. In some embodiments, the feature extraction technique may be a statistical analysis technique.

At step 312, the method 300 may include, providing the plurality of sub-domain identifiers as an input to a hypernetwork. In some embodiments, once the plurality of sub-domain identifiers is extracted, the method 300 may include embedding the plurality of sub-domain identifiers in a standard template for processing the plurality of sub-domain identifiers to the hypernetwork. Further, the method 300 terminated at step 314.

FIG. 4 illustrates a flow diagram of a method 400 for training the PINO, in accordance with an example embodiment. It will be understood that each block of the flow diagram of the method 400 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 4 is explained in conjunction with elements from FIGS. 1, 2, and 3. As explained earlier, the plurality of sub-domain identifiers may be provided as an input to the hypernetwork, the hypernetwork may be utilized to train the PINO. The present FIG. 4 illustrates the method 400 for training the PINO.

At step 402, the method 400 is initiated.

As explained earlier, once the plurality of sub-domain identifiers is provided as the input to the hypernetwork, the method 400, at step 406 may further include generating combinations of parameters of the system that are to be varied.

Further, the method 400, at step 408, may include iteratively training the PINO with the combinations of parameters until an error rate falls below a predefined threshold. The method 400 ends at step 410.

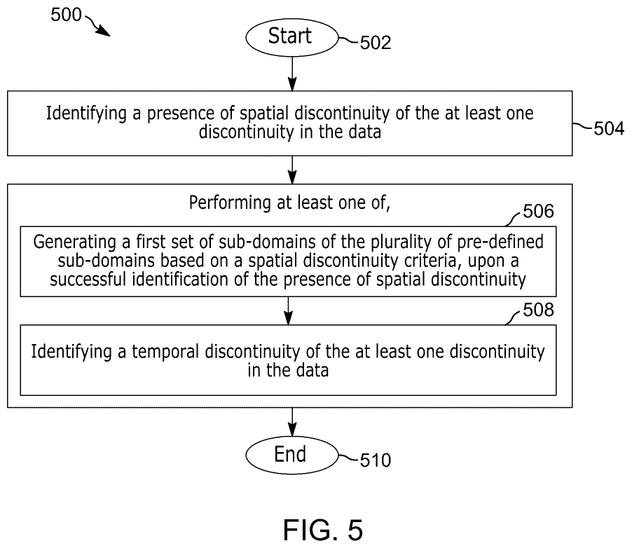

FIG. 5 illustrates a flow diagram of a method 500 for generating a plurality of sub-domains, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 5 is explained in conjunction with elements from FIGS. 1, 2, 3, and 4. As discussed in reference to FIG. 3, the plurality of sub-domains may be generated for the target domain. The method 500 is started at step 502. Therefore, generating the plurality of sub-domains, at step 504, may include identifying a presence of spatial discontinuity of the at least one discontinuity in the data. The spatial discontinuity may correspond to abrupt spatial variations in the data. The spatial variations may include variations in geometrical parameter, or sharp change in boundary conditions with respect to spatial coordinate.

Upon a successful identification of the presence of spatial discontinuity, the method 500, at step 506 may further include generating a first set of sub-domains of the plurality of pre-defined sub-domains based on spatial discontinuity criteria.

Upon an unsuccessful identification of the presence of spatial discontinuity, the method 500, at step 508 may further include identifying a temporal discontinuity of the at least one discontinuity in the data. The method 500 terminates at step 510.

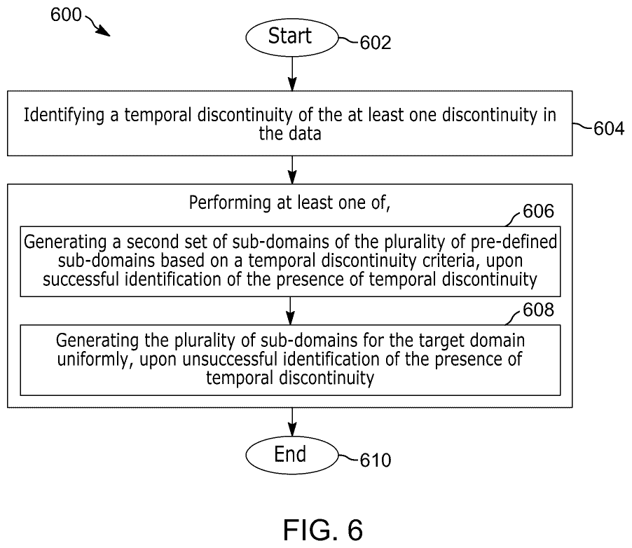

FIG. 6 illustrates a flow diagram of a method 600 for generating a plurality of sub-domains, in accordance with an example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 6 is explained in conjunction with elements from FIGS. 1, 2, 3, 4, and 5. The method 600 is started at step 602. The method, at step 604, may include identifying a temporal discontinuity of the at least one discontinuity in the data. The spatial discontinuity may correspond to abrupt spatial variations in the data. The temporal discontinuity may correspond to abrupt temporal variations in the data. The temporal variations may include sudden shock or sharp change in the boundary conditions with respect to time.

Upon successful identification of the presence of temporal discontinuity, the method 600, at step 606 may further include generating a second set of sub-domains of the plurality of pre-defined sub-domains based on a temporal discontinuity criterion.

Upon an unsuccessful identification of the presence of temporal discontinuity, the method 600, at step 608 may further include generating the plurality of sub-domains for the target domain uniformly. The method 600 terminates at step 610.

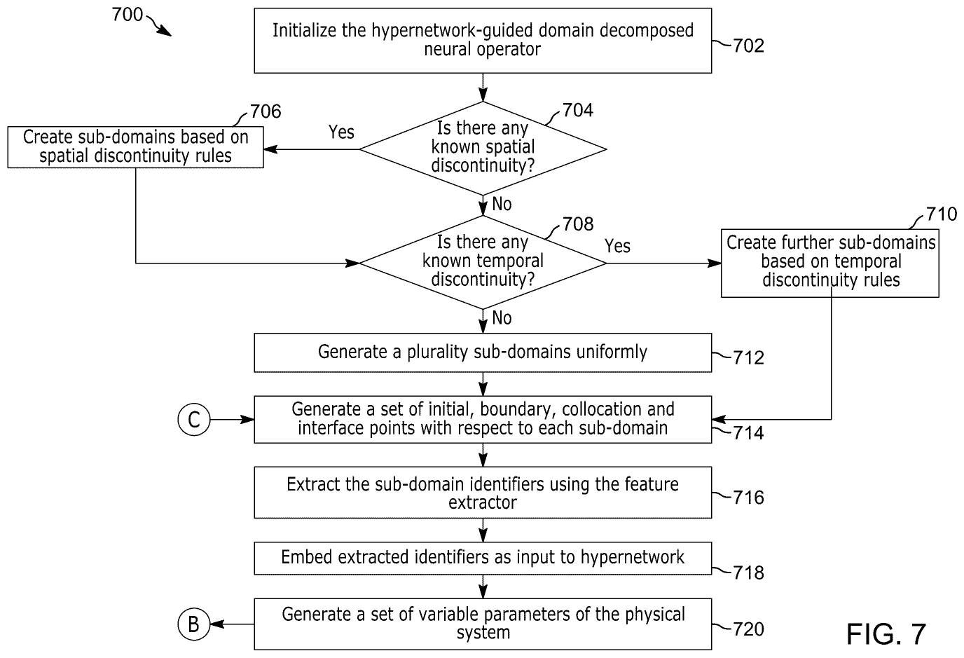

FIG. 7 illustrates an exemplary process flow 700 for generating a set of variables for a physical system, in accordance with an example embodiment. The process flow 700 begins with the initialization of the hypernetwork-guided domain decomposed neural operator, at step 702.

Following this, a decision is made to check if there is any known spatial discontinuity, at step 704. Spatial discontinuity may refer to abrupt changes in spatial characteristics such as boundary conditions, geometries, or material properties within the system. If there is known spatial discontinuity, the process flow 700 may create sub-domains based on spatial discontinuity rules, at step 706. These rules may define how the spatial domain should be partitioned to account for the discontinuity, ensuring accurate representation and analysis of the system.

Further a decision is made to check if there is known temporal discontinuity, at step 708. Temporal discontinuity may signify sudden variations in temporal behavior, trends, or events observed over time. If there is known temporal discontinuity, the process flow 700 may create further sub-domains based on temporal discontinuity rules. If there is no known temporal discontinuity, the process flow 700 may generate a plurality of sub-domains uniformly, at step 712.

The process flow 700 may then generate a set of initial, boundary, collocation, and interface points with respect to each sub-domain, at step 714. Initial points may represent the starting conditions or initial state of the system within each sub-domain. These points serve as the initial conditions for simulating the evolution of the system over time. They provide the initial values of relevant variables or parameters at the beginning of the simulation.

Further, the boundary points may define the boundaries or edges of each sub-domain within the overall domain. These points set a spatial extent of each sub-domain and help to establish the boundary conditions that govern the behavior of the system at its boundaries.

Further, the collocation points may be strategically placed within each sub-domain to enforce physics-informed constraints or equations. These points serve as reference locations where the governing equations or constraints are enforced to ensure that the simulated solutions satisfy the underlying physics of the system. Collocation points help ensure the accuracy and fidelity of the simulation by enforcing physical consistency throughout the domain.

Additionally, the interface points may be located at the interfaces or boundaries between adjacent sub-domains. These points facilitate communication and interaction between neighboring sub-domains, ensuring continuity and coherence across the domain decomposition. Interface points enable the exchange of information, variables, or parameters between adjacent sub-domains, allowing for seamless integration and coordination in the simulation process.

Following this, the process flow 700 may extract the sub-domain identifiers using the feature extraction module, at step 716 The sub-domain identifiers may be features or descriptors that encapsulate the unique characteristics of each sub-domain within the hyper-domain. These identifiers provide valuable information about the spatial and temporal patterns, distributions, and attributes present in the data. Examples of sub-domain identifiers include:

Centre Point: The central location or centroid of each sub-domain, representing its spatial position within the overall domain.

Spatial Distribution: Statistical measures such as mean, standard deviation, skewness, or kurtosis of data points within each sub-domain, quantifying the distribution and variability of values.

Spatial Gradients: Gradient vectors or derivatives computed from data points within each sub-domain, capturing spatial variations or trends in the data.

Spatial Patterns: Recognizable spatial patterns or structures present within each sub-domain, such as clusters, clusters, or spatial arrangements of data points.

Once the sub-domain identifiers are extracted, the extracted identifiers may be embedded as input to the hypernetwork, at step 718. Embedding involves transforming the identifiers into a numerical representation that may be processed by the hypernetwork. This embedding process ensures that the hypernetwork receives relevant information about each sub-domain, facilitating accurate parameter generation and analysis. The embedding may include:

Collocation Embeddings: Embeddings of collocation points within each sub-domain encode the locations where physics-informed constraints or equations are enforced. These embeddings enable the hypernetwork to incorporate the constraints into the parameter generation process, ensuring that the generated parameters satisfy the underlying physics of the system.

Interface Embeddings: Embeddings of interface points at the boundaries between adjacent sub-domains facilitate communication and interaction between neighboring regions. These embeddings allow the hypernetwork to capture the interplay between adjacent sub-domains and ensure continuity and coherence across the domain decomposition.

Boundary Condition (BC) Embeddings: Embeddings representing boundary conditions at the boundaries of each sub-domain encode the prescribed conditions or constraints governing the behavior of the system at its boundaries. These embeddings enable the hypernetwork to incorporate boundary conditions into the parameter generation process, ensuring consistency with the physical constraints of the system.

Finally, the process flow 700 may generate a set of variable parameters of the physical system. The set of parameters may include, but may not be limited to, boundary conditions, initial comedications, material properties, and dimensions parameters.

Boundary Conditions (BCs): Boundary conditions specify the behavior or constraints imposed on the system at its boundaries. These conditions dictate how the system interacts with its external environment or neighboring regions. Examples of boundary conditions include fixed values, prescribed fluxes, or derivative conditions applied at the boundaries of the domain.

Initial Conditions (ICs): Initial conditions define the state or configuration of the system at the beginning of the simulation or analysis. These conditions specify the initial values of relevant variables, parameters, or fields within the domain. Examples of initial conditions include temperature distributions, velocity profiles, or concentration gradients at the start of the simulation.

Material Properties: Material properties characterize the physical properties and behavior of the materials or substances present within the system. These properties include parameters such as density, conductivity, viscosity, elasticity, or permeability, which govern the material's response to external forces or stimuli. Material properties play a crucial role in determining the system's overall behavior and dynamics.

Dimensions and Geometric Parameters: Dimensions and geometric parameters describe the spatial configuration, shape, and size of the system's components or domains. These parameters include dimensions, lengths, widths, heights, angles, or curvature values that define the geometry of the system. Geometric parameters influence the system's spatial layout, boundary shapes, and overall topology.

Other Relevant Information: Additionally, the set of variable parameters may include any other relevant information or specifications necessary for simulating and analyzing the physical system effectively. This may encompass environmental conditions, external forces, operating parameters, or any other factors that influence the system's behavior and response.

By generating the set of variable parameters encompassing boundary conditions, initial conditions, material properties, dimensions, and other relevant information, the process flow 700 enables a thorough characterization and simulation of the physical system. These parameters serve as inputs to the simulation models or neural operators, guiding the analysis and providing insights into the system's behavior, dynamics, and performance.

FIG. 8 illustrates an exemplary process flow 800 for training the PINO, in accordance with an example embodiment. The process flow 700 begins with the training of a model until the error is less than a final threshold, at step 702.

The training process follows an iterative loop, where the model is trained over multiple epochs (iterations) until the specified convergence criteria are met. Each iteration of the loop involves updating the model parameters based on the training data and evaluating the model's performance. Within each iteration of the training loop, the DomainDecomp_NO (Domain Decomposed Neural Operator) model is trained using the specified architecture and training parameters. This model incorporates the hypernetwork-guided domain decomposition technique for enhanced accuracy and efficiency in learning complex physical systems.

The training process continues for a predefined number of epochs, denoted by ‘e1’. During each epoch, the model learns from the training data and adjusts its parameters to minimize the training error. The process maintains a count of the iterations (i) performed during the training process. This count increments with each iteration of the training loop, reflecting the progression of the training procedure.

Following this, a decision is made. the decision checks if the error is less than a threshold, at step 804. If the error is less than the threshold, the process proceeds to save the final model along with all sub-domain definitions and hypernetwork parameters.

If the error is found to be more than the threshold at step 804, then at step 806, the sub-domains where the error is more than the threshold are identified. Each of these identified sub-domains is further split uniformly into “n” child domains. Conversely, for the sub-domains where error remains below the threshold, no further splitting is done, and they are kept unchanged. Following this process, the flow returns to step 714 in FIG. 7, where new sets of interior, collocation, boundary and interface points are generated for newly divided sub-domains from step 806. This automatic sub-division of sub-domains continues iteratively until the accuracy criteria is met, facilitating the automatic fine-tuning of sub-domains, and ensuring the iterative identification of the optimal sub-domain division.

If the error is not less than the threshold, the process trains till error becomes less than a final threshold, at step 808. More specifically, after the sub-domains are split, the process returns to the initial step of training the model until the error is less than the final threshold. This iterative process continues until the error falls below the final threshold, at which point the final model is saved along with all sub-domain definitions and hypernetwork parameters, at step 810.

This process flow provides a systematic approach for hypernetwork guided domain decomposition in PINOs, enabling the learning of highly nonlinear systems with long temporal domains and discontinuities without imposing additional computational cost. In a more elaborative way, the present disclosure uses hypernetworks for representing the spatial and temporal sub-domains by learning a set of different parameters for each of them. Use of hypernetwork eliminates the need for learning separate networks for various sub-domains. This also assist in addressing the non-linearities, discontinuities in the solution effectively. Additionally, the present disclosure proposes a method for automated and adaptive ‘learning’ of sub-domains during the training process of PINO. The method also enables automatic extraction of sub-domain identifiers and embedding those identified in a uniform template so as to pass them as input to the hypernetwork. This method combines identifier extraction, automated division based on convergence in each sub-domain and automated embedding of identifiers in the input layer of hypernetwork.

FIG. 9 illustrates an exemplary architecture 900 of neural operator for hypernetwork guided decomposition, in accordance with an example embodiment. It should be noted that while this architecture is specifically depicted using a DeepONet framework, it serves as an example and can be adapted for various hypernetwork-guided decomposition approaches. The architecture comprises three main components: a branch network 902, a trunk network 904, and a hypernetwork 906.

The branch network 902 and trunk network 904 are essential components responsible for processing input data and extracting relevant features. The branch network 902 focuses on capturing local features and patterns within the input data, while the trunk network 904 focuses on capturing global features and contextual information. In particular, the branch network 902 may focus on iterative training of the neural operator by taking combinations of parameters of the physical system as input, facilitating iterative training until the error falls below a predefined threshold. These networks work in cycle to extract hierarchical representations of the input data, facilitating effective feature extraction for subsequent processing.

The hypernetwork 906 plays a fundamental role in the hypernetwork-guided decomposition process. It is responsible for dynamically adjusts the network's weights based on the extracted features from the branch and trunk networks. By utilizing the hypernetwork, the architecture may adaptively decompose the input domain into meaningful subdomains and generate customized solutions tailored to the specific characteristics of each subdomain.

Connecting the input of the hypernetwork 906 and trunk network 904 to the feature extractor 908 ensures that the extracted features are appropriately processed and utilized by the hypernetwork. The feature extractor 908 refines the extracted features, enhancing their representational capacity and ensuring compatibility with the hypernetwork's input requirements.

Additionally, the architecture includes a decomposition domain 910, which serves as the interface for defining the decomposition strategy and guiding the hypernetwork-guided decomposition process. This domain encapsulates the spatial and temporal characteristics of the input data, providing crucial information for the decomposition process.

The output of both the branch network 902 and trunk network 904 is connected to a temperature nonlinear decoder 912. This decoder is responsible for decoding the extracted features and generating the final output, which may include predictions, solutions, or representations of the input data. Furthermore, the output from the temperature nonlinear decoder 912 is fed into an automatic differentiation module, which computes the partial differential equations (PDEs), boundary conditions (BCs), and initial conditions (ICs) losses. These losses provide feedback to the network during training, guiding parameter updates and ensuring convergence towards accurate solutions.

Overall, the exemplary architecture 900 demonstrates how a neural operator can be designed to effectively integrate hypernetwork-guided decomposition techniques, enabling adaptive and customized solutions for complex data.

As will be appreciated by those skilled in the art, the techniques described in the various embodiments discussed above are not routine, or conventional, or well understood in the art. The techniques discussed above provide for innovative solutions to address the challenges associated with hypernetwork-guided domain decomposition in PINOs. By integrating hypernetworks with domain decomposition strategies, the disclosed techniques offer several distinct advantages.

Firstly, the utilization of hypernetworks enables the co-learning of parameters for each sub-domain within the hyper-domain, eliminating the need for separate networks for individual sub-domains. This approach significantly reduces computational costs and simplifies the training process, making it more efficient and scalable for analyzing complex systems.

Additionally, the automated and adaptive domain decomposition strategy enhances the flexibility and adaptability of the system. By dynamically adjusting the size and number of sub-domains based on the characteristics of the input data, the system may effectively handle nonlinearities, discontinuities, and complex geometries without manual intervention. This adaptability ensures robust performance across a wide range of applications and scenarios.

Furthermore, the incorporation of feature extraction techniques enhances the representational power of the hypernetwork, enabling it to capture spatial and temporal patterns inherent in the data. This comprehensive understanding of the underlying physics of the system leads to more accurate predictions and solutions, ultimately improving the reliability and utility of the PINOs in real-world applications.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A computer-implemented method for hypernetwork guided domain decomposition in Physics-Informed Neural Operators (PINOs), comprising:
identifying a presence of at least one discontinuity in data associated with a target domain to be analyzed by a PINO, wherein identification of the presence is at least of a successful identification or an unsuccessful identification;
generating a plurality of sub-domains for the target domain, wherein the plurality of sub-domains is generated uniformly upon the unsuccessful identification, and wherein the plurality of sub-domains is generated based on a predefined discontinuity criteria upon the successful identification;
generating intra-subdomain points with respect to each of the plurality of sub-domains;
extracting a plurality of sub-domain identifiers corresponding to each of the plurality of subdomains, upon generating the intra-subdomain points, using a pre-defined feature extraction technique; and
providing the plurality of sub-domain identifiers as an input to a hypernetwork.

2. The computer-implemented method of claim 1, further comprising embedding the plurality of sub-domain identifiers in a standard template for processing the plurality of sub-domain identifiers to the hypernetwork.

3. The computer-implemented method of claim 1, wherein generating the plurality of sub-domains comprises identifying a presence of spatial discontinuity of the at least one discontinuity in the data, further comprising:
performing at least one of,
upon a successful identification of the presence of spatial discontinuity, generating a first set of sub-domains of the plurality of pre-defined sub-domains based on a spatial discontinuity criterion; or
upon an unsuccessful identification of the presence of spatial discontinuity, identifying a temporal discontinuity of the at least one discontinuity in the data.

4. The computer-implemented method of claim 3, further comprising:
upon successful identification of the presence of temporal discontinuity, generating a second set of sub-domains of the plurality of pre-defined sub-domains based on a temporal discontinuity criterion; or
upon unsuccessful identification of the presence of temporal discontinuity, generating the plurality of sub-domains for the target domain uniformly, in all dimensions.

5. The computer-implemented method of claim 3, wherein the spatial discontinuity corresponds to abrupt spatial variations in the data, and wherein the spatial variations comprise variations in geometrical parameter, or sharp change in boundary conditions with respect to spatial coordinate.

6. The computer-implemented method of claim 3, wherein the temporal discontinuity corresponds to abrupt temporal variations in the data, and wherein the temporal variations comprise sudden shock or sharp change in the boundary conditions with respect to time.

7. The computer-implemented method of claim 1, further comprising generating combinations of parameters of a physical system that are to be varied.

8. The computer-implemented method of claim 1, wherein the infra-subpoints comprise initial points for training, boundary points, collocation points for enforcing physics-informed constraints, and interface points between adjacent sub-domains for maintaining physical continuity.

9. The computer-implemented method of claim 1, further comprising iteratively training the PINO with the combinations of parameters until an error falls below a predefined threshold.

10. The computer-implemented method of claim 9, further comprising:
saving a final model of PINO along with all sub-domain definitions and hypernetwork parameters when the error falls below the threshold; or
splitting sub-domains uniformly into a set of child domains when the error is more than the threshold, wherein new sets of interior, collocation, boundary, and interface points are generated for the child domains.

11. The computer-implemented method of claim 1, wherein the feature extraction technique is a statistical analysis technique.

12. The computer-implemented method of claim 1, wherein the sub-domains are automatically refined, and optimal sub-domain division is automatically identified through iteratively training and evaluating the PINO model.

13. A computer system for hypernetwork guided domain decomposition in Physics-Informed Neural Operators (PINOs), the computer system comprising: one or more computer processors, one or more computer readable memories, one or more computer readable storage devices, and program instructions stored on the one or more computer readable storage devices for execution by the one or more computer processors via the one or more computer readable memories, the program instructions comprising:
identifying a presence of at least one discontinuity in data associated with a target domain to be analyzed by a PINO, wherein identification of the presence is at least of a successful identification or an unsuccessful identification;
generating a plurality of sub-domains for the target domain, wherein the plurality of sub-domains is generated uniformly upon the unsuccessful identification, and wherein the plurality of sub-domains is generated based on a predefined discontinuity criteria upon the successful identification;
generating intra-subdomain points with respect to each of the plurality of sub-domains;
extracting a plurality of sub-domain identifiers corresponding to each of the plurality of subdomains, upon generating the intra-subdomain points, using a pre-defined feature extraction technique; and
providing the plurality of sub-domain identifiers as an input to a hypernetwork.

14. The computer system of claim 13, further comprising embedding the plurality of sub-domain identifiers in a standard template for processing the plurality of sub-domain identifiers to the hypernetwork.

15. The computer system of claim 13, wherein generating the plurality of sub-domains comprises identifying a presence of spatial discontinuity of the at least one discontinuity in the data wherein the spatial discontinuity corresponds to abrupt spatial variations in the data, and wherein the spatial variations comprise variations in in geometrical parameter, or sharp change in boundary conditions with respect to spatial coordinate.

16. The computer system of claim 13, further comprising:
performing at least one of,
upon a successful identification of the presence of spatial discontinuity, generating a first set of sub-domains of the plurality of pre-defined sub-domains based on a spatial discontinuity criterion; or
upon an unsuccessful identification of the presence of spatial discontinuity, identifying a temporal discontinuity of the at least one discontinuity in the data.

17. The computer system of claim 15, further comprising:
upon successful identification of the presence of temporal discontinuity, generating a second set of sub-domains of the plurality of pre-defined sub-domains based on a temporal discontinuity criterion; or
upon unsuccessful identification of the presence of temporal discontinuity, generating the plurality of sub-domains for the target domain uniformly
generating combinations of parameters of a physical system that are to be varied.

18. The computer-implemented method of claim 14, wherein the temporal discontinuity corresponds to abrupt temporal variations in the data, and wherein the temporal variations comprise sudden shock or sharp change in the boundary conditions with respect to time.

19. The computer system of claim 13 further comprising
training iteratively the PINO with the combinations of parameters until an error falls below a predefined threshold
saving a final model of PINO along with all sub-domain definitions and hypernetwork parameters when the error falls below the threshold; or
splitting sub-domains uniformly into a set of child domains when the error is more than the threshold, wherein new sets of interior, collocation, boundary, and interface points are generated for the child domains.

20. A non-transitory computer-readable storage medium having stored thereon computer executable instruction which when executed by one or more processors, cause the one or more processors to carry out operations for hypernetwork guided domain decomposition in Physics-Informed Neural Operators (PINOs), the operations comprising perform the operations comprising:
identifying a presence of at least one discontinuity in data associated with a target domain to be analyzed by a PINO, wherein identification of the presence is at least of a successful identification or an unsuccessful identification;
generating a plurality of sub-domains for the target domain, wherein the plurality of sub-domains is generated uniformly upon the unsuccessful identification, and wherein the plurality of sub-domains is generated based on a predefined discontinuity criteria upon the successful identification;
generating intra-subdomain points with respect to each of the plurality of sub-domains;
extracting a plurality of sub-domain identifiers corresponding to each of the plurality of subdomains, upon generating the intra-subdomain points, using a pre-defined feature extraction technique; and
providing the plurality of sub-domain identifiers as an input to a hypernetwork.
